(19) United States
(12) Patent Application Publication
(10) Pub. No.: US 2005/0080674 A1
(43) Pub. Date: Apr. 14, 2005

(54) Seat back advertising panel, system, program product, and related methods

(75) Inventor: Arthur A. Howard, Houston, TX (US)

Correspondence Address: BRACEWELL & PATTERSON, LLP;IP DOCKETING, P.O. BOX 61389, HOUSTON, TX, 77208-1389, US

(73) Assignee: Horizon Professional Advisors, Ltd.

(21) Appl. No.: 11/003,874

(22) Filed: Dec. 3, 2004

Related U.S. Application Data
(60) Provisional application No. 60/584,660, filed on Jun. 30, 2004.

(51) Int. Cl. G06F 17/60

(52) U.S. Cl. 705/14

(57) ABSTRACT

An advertising business method which includes removable and replaceable panels for display on the backs of seats in stadium, arena and other multi-purpose venues, for making one or more visual advertisements on the surface of the seat backs. A seat back advertising panel, system, program product, and methods for enhancing and tracking target audience and user response activity, and for rewarding user response and promotional participation are also provided.

### 1. RELATED APPLICATIONS

This application claims the benefit of and priority from U.S. Provisional Patent Application Ser. No. 60/584,660, filed on Jun. 30, 2004 titled “Seat Back Advertising Panel, System, and Related Methods,” incorporated herein by reference in its entirety.

### BACKGROUND OF THE INVENTION

1. Field of the Invention

The present invention relates to the advertising industry and, more particularly, to advertising systems and methods in various multi-purpose venues.

2. Description of Related Art

Over the years, advertising has emerged in numerous locations in everyday life. Traditional advertising such as through television, radio, magazines, mail flyers and billboards also has expanded greatly. More recently, advertising now occurs directed to users of gas station pumps, to passengers on airplanes, to users of turn-styles at stadiums, to users of the Internet, to attendees at stadiums, arenas, and other multipurpose venues such as by the use of signage along walls, fences, tables, and scoreboards to viewers of car racing such as by logos, branding, and trademarks directly on sports car, and to music and software uses such as by compact disc casings.

Nevertheless, the advertising industry continues to seek identifiable segmented audience and medium through which to reach target audiences, especially to build brand loyalty. Various locations of advertising within stadiums are currently known to exist, for example, on an armrest of a seat such as shown in U.S. Pat. No. 5,533,782 by Goldman titled “Device For Storing And Displaying Materials On A Stadium Armrest,” on a grandstand such as shown in U.S. Published U.S. Pat. No. 5,941,002 by Rusin titled “Stadium Signage System And Method,” and on steps such as shown in U.S. Patent Application Nos. 2003/0194538 and 2004/0071915 by Keane et al and Keane respectively and each titled “Advertising System.”

There is, however, a continued need to generate revenue such as through advertising at stadiums, arenas, concert halls, theatres, and other multipurpose venues that enhances advertising impact on attendees of sporting events, concerts, plays, shows, and other attractions. There also is a continued need to enhance advertising association and tracking for advertisers, sports teams, sponsors of events and attractions, and other host organizations, in order to build brand loyalty for selected target audiences.

### SUMMARY OF THE INVENTION

In view of the foregoing, embodiments of the present invention advantageously provide a seat back advertising panel, system, program product, and related method that optimizes the visual acuity of a captive and highly attentive audience within multipurpose venues such as stadiums, and transforms each seat back into a valuable, revenue producing media asset. Designed to generate revenue for organizations offering multi-purpose-venue (“MPV”)-advertising packages, the program employs a novel and customized strategy for utilizing the seat backs of MPV chairs for company, product and brand messaging.

Embodiments of the present application provide an advertising business method for use of a removable and replaceable panel for application and attachment to the back surface of seats in stadium, arena and multi-purpose venues and for the purpose of displaying host organization and third-party paid visual advertisement on the viewing surface of the panel. For example, in an embodiment of the present invention the method includes the steps of attaching a removable and replaceable panel to a back surface of seats in a multi-purpose venue; and displaying at least one third-party paid visual advertisement on a viewing surface of the panel. The viewing surface has a substrate with a pre-selected thickness, a coloration material associated with the substrate forming a desired advertising pattern of at least one color, and a removable backing. The third-party paid visual advertisement preferably includes indicia indicating a product-promotional prize-drawing game of chance, and indicia indicating a call-to-action advertisement displayed on the viewing surface of the panel. The call-to-action advertisement can include a web-based address for an interactive website accessible through a user interface having access to a communication network.

Embodiments of the present invention also provide a method for sequentially rotating and spacing multiple panels, utilizing the maximum direct and peripheral viewing range originating from the seated position in a seat within a stadium, arena or multi-purpose venue, and optimizing the visual acuity of the target audience within a stadium, arena or multi-purpose arena. For example, in an embodiment of the present invention, the method includes the step of positioning each of a plurality of different advertising panels on a back of a different seat in a multi-purpose venue, whereby each of the plurality of advertising panels have a plurality of indicia each indicating a corresponding different promotional advertisement and preferably positioned in a sequential order.

Embodiments of the present invention also provide a method of entering an advertising arrangement for at least one but preferably a plurality of advertisers to advertise on a plurality of seat backs in a multi-purpose venue. For example, in an embodiment of the present invention, the method includes the steps of soliciting from at least one advertiser, participation in an advertising program that promotes contest-based incentives as rewards for responding to advertisements tailored for each advertiser, and displaying the at least one advertiser's advertisement on the plurality of seat back positioned advertising panels in a multi-purpose venue. Advantageously, the advertising panels can include at least one advertisement having indicia of a product-promotional prize-drawing game of chance. The method can also include providing a homepage associated with an interactive website having an advertisement corresponding with the at least one advertiser's advertisement displayed on the plurality of seat back positioned advertising panels of the advertising program.

Embodiments of the present application additionally provide a system for optimizing target audience and user activity, by promoting contest-based or other incentives as rewards for responding to contests and advertised promotional participation opportunities, including a call-to-action displayed on the viewing surface of panels. For example, in an embodiment of the present invention, a system includes a call-to-action advertisement displayed on a viewing surface of an advertising panel and which advantageously can include a web-based address. The system also includes an interactive web-based program or program product accessible through a user interface having access to a communications network. The web-address can access a homepage designed to place a pre-selected form of web advertising for the different promotional participation opportunities and contests of each advertiser or host organization participating in an advertising program displayed in prominent view on the homepage. Associated hyperlinks on the homepage direct users to multiple secondary web pages describing the terms of each contest and a product-promotional prize-drawing game of chance sponsored by an advertiser or host organization participating in the advertising program. An associated hyperlink directs a user to a subsequent web page that facilitates the registration of the user through the collection of identifying data entered into a registration form. Another associated hyperlink allows the user to register the identifying data in any one or more of the different promotional opportunities and contests sponsored by each advertiser or host organization participating in the advertisement program.

Embodiments of the present application further provide a system for tracking user activity and producing participation statistics related to this tracking system. Embodiments of the present invention still further provide a system for strategically integrating any two or more of the foregoing methods and systems, and offering these methods and systems as a managed or standalone program and business solution for generating advertising revenue and achieving business objectives.

Advantageously, this business method and advertising system can add substantial revenue to existing MPV-advertising enterprises and host organizations. This comprehensive system can be advantageously positioned to utilize current physical property to create new advertising revenue streams. This system can be used to maximize direct visitor exposure to a brand being promoted, and provides a “call-to-action” program for the consumers exposed to the advertised message. This system assists advertisers with building strong brand relationships and recall with consumers beyond traditional stadium promotions. The seat back advertising system turns every seat back in an MPV stadium into a potential profit center, as each one becomes a mini-billboard, thus affording advertisers with the opportunity to enhance their brand power through extended, constant and direct consumer exposure that provides premium visibility.

Embodiments of the present invention also provide a computer readable medium that is readable by a computer to enhance target audience and consumer activity by promoting contest-based incentives as rewards for responding to advertisements having indicia of a product-promotional prize-drawing game of chance and displayed on a plurality of seat back positioned advertising panels of an advertising program. For example, in an embodiment of the present invention, the computer readable medium includes a set of instructions or program product that, when executed by the computer, cause the computer to perform the operations of: displaying a home page having a plurality of different advertisements corresponding with the advertisement displayed on the plurality of seat back positioned advertising panels of the advertising program; and displaying a plurality of participant consumer selectable hyperlinks to provide selection of a product-promotional prize-drawing game of chance of interest.

Operations performed also include: providing at least one registration form in response to the participant consumer selecting the product-promotional prize-drawing game of chance of interest. The registration form has a set of data entry fields and a participant consumer selectable hyperlink to an advertiser's website associated with the homepage. Advantageously, the registration form can facilitate registration of the participant consumer for the selected product-promotional prize-drawing game of chance of interest through the collection of participant consumer unique identifying data entered into the registration form. Operations performed also include collecting the participant consumer unique identifying data from the registration form, in response to the participant consumer entering participant consumer unique identifying data into the data entry fields of the registration form and selecting the associated participant consumer selectable hyperlink. This information can then advantageously be transmitted to the advertiser's website associated with the homepage and to the host company.

In conjunction with the gathering of the participant consumer's unique identifying data, operations performed also include displaying the advertiser's website to allow the participant consumer to view the advertiser's products and/or services. Further, advantageously, once the participant consumer initiates exit from the advertiser's website associated with the homepage, a hyperlink back to the homepage can be displayed. Advantageously, this function not only provides the participant consumer access to another product-promotional prize-drawing game of chance for another advertiser, but provides an increased probability that the other advertisers products and services will be viewed.

Further, proprietary website tracking of an embodiment of a system of the present invention will not only register participants responding to the “call-to-action” program, but it can also track each advertiser's contest participation and response rate, and broker the attention of each consumer by directing them to each advertiser's website. For example, a consulting firm, signage company or other entity can be responsible for handling program management, product specification, manufacturing, as well as packaging and fulfillment. It can also coordinate and manage the website tracking system aspects of the program, and maintain the integrity of information collected by the registering consumers, as well as coordinate the announcement and delivery of all prizes awarded by each advertiser.

### BRIEF DESCRIPTION OF THE DRAWINGS

Some of the features, advantages, and benefits of the present invention having been stated, others will become apparent as the description proceeds when taken in conjunction with the accompanying drawings in which:

FIG. 1 is a fragmentary environmental view of multi-purpose venue seating according to an embodiment of the present invention;

FIG. 2 is a perspective view of a single seat having seat back advertising according to an embodiment of the present invention;

FIG. 3 is a fragmentary perspective view of a seat having a seat back advertising panel according to an embodiment of the present invention;

FIG. 4 is a front plan view of a seat back advertising panel according to an embodiment of the present invention;

FIG. 5A is a perspective environmental view of a seat back advertising system according to an embodiment of the present invention;

FIG. 5B is a perspective environmental view of a seat back advertising system according to an embodiment of the present invention;

FIG. 5C is a perspective environmental view of a seat back advertising system according to an embodiment of the present invention;

FIG. 6 is a schematic diagram of a communications network of a seat back advertising system according to an embodiment of the present invention;

FIGS. 7A-7D are perspective views of a user interface of a seat back advertising system according to an embodiment of the present invention;

FIGS. 8A-8D are front plan view of graphical user interfaces being viewed by users that enter a website of a seat back advertising system according to an embodiment of the present invention;

FIG. 9 is a block diagram of software to be stored on a remote server of a seat back advertising system according to an embodiment of the present invention;

FIG. 10 is a flow diagram of a method of doing business according to an embodiment of the present invention; and

FIG. 11 is a flow diagram of a method of entering an advertising arrangement according to an embodiment of the present invention.

### DETAILED DESCRIPTION

The present invention will now be described more fully hereinafter with reference to the accompanying drawings which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. The prime, double prime, and triple prime notation, if used, indicates similar elements in alternative embodiments.

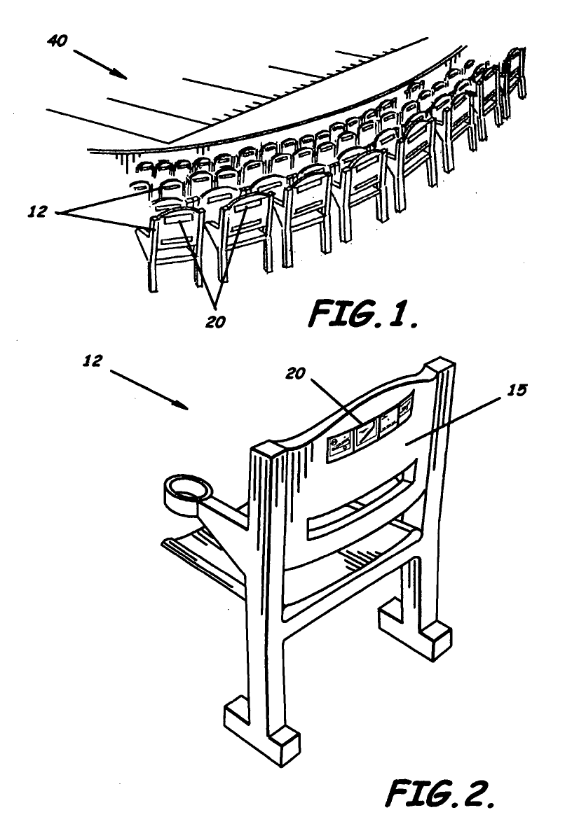

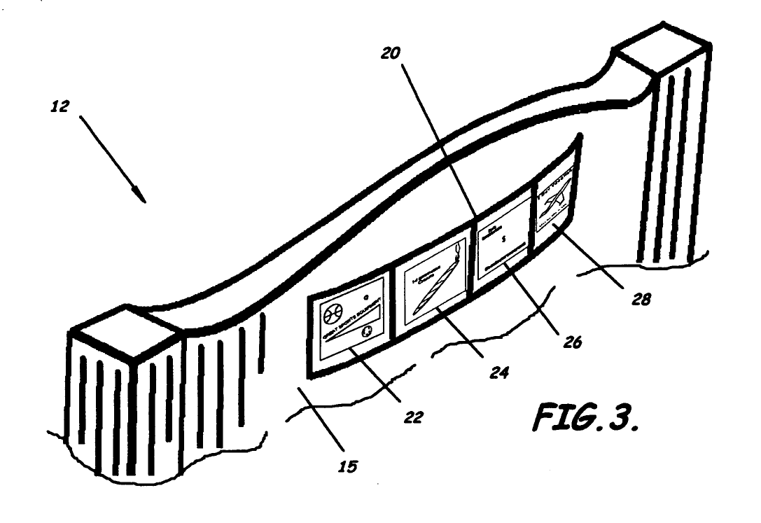

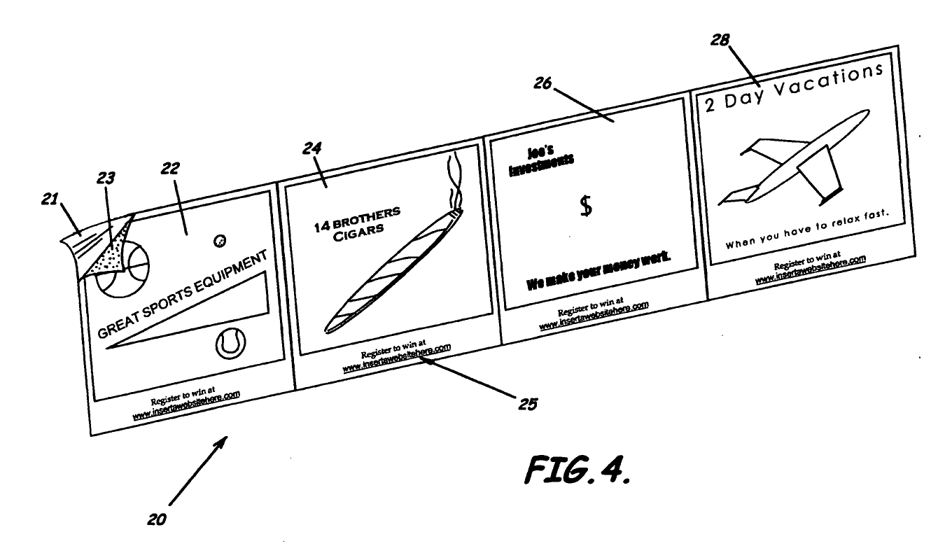

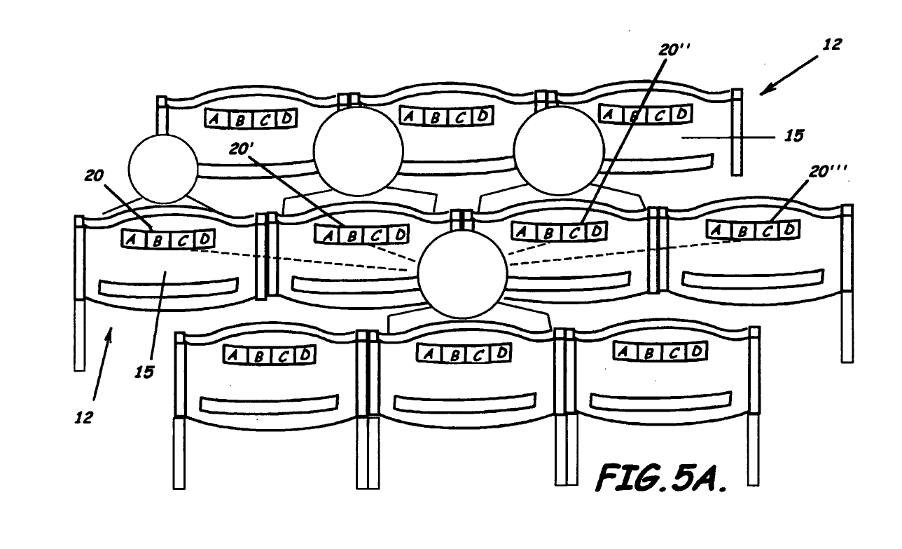

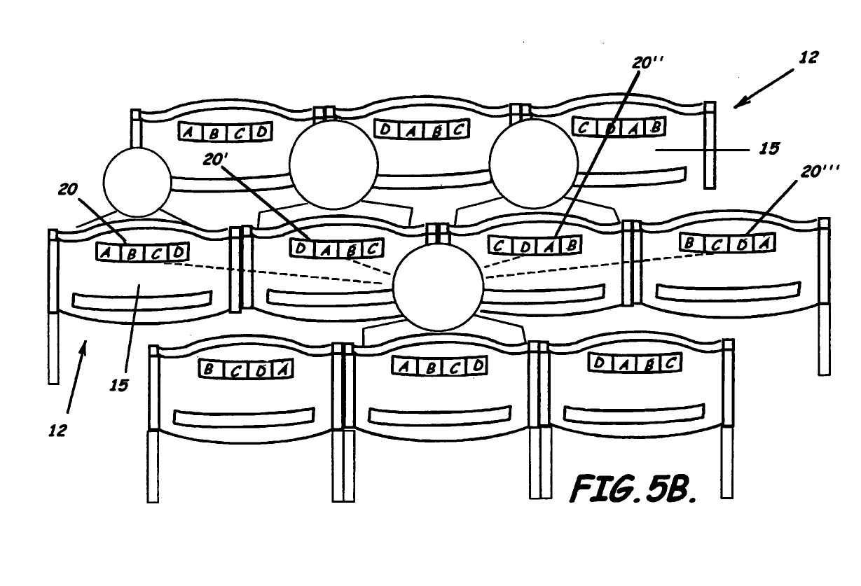

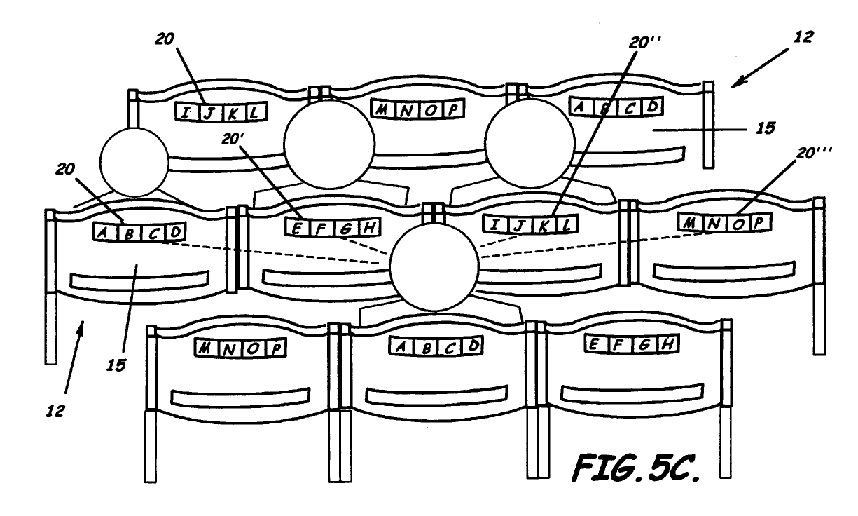

As illustrated in FIGS. 1-5, each seat back 15 of an embodiment of a seat back advertising system 30, for example, features a very simple adhesive panel 20, sized to create a plurality of advertisements or ad spots, e.g., in the preferred embodiment of the present invention, four equally sized advertisement sub-panels 22, 24, 26, 28 can include advertisements, such as, for example, advertisements A, B, C, D (see FIGS. 4, 5A-C) which can have indicia of a product-promotional prize-drawing game of chance or contest that fit within an immediate field of view on the back 15 of each seat 12. In the preferred embodiment of the present invention, each panel 20 can be divided into a plurality of distinct equally sized sub-panels 22, 24, 26, 28, e.g., four squared sub-panels, so that the revenue producing potential of each panel 20 is optimized and so that no one advertisement will substantially diminish the intrinsic value or revenue potential of the others. The four a sub-panels 22, 24, 26, 28 within each panel 20, for example, can be reserved for advertisers' brands consistent with a host organization's sponsor, brand and advertising protocol. Perhaps as best shown in FIGS. 1 and 5, in order to minimize over-saturation of any one impression within a consumer's immediate field of view (defined by way of example only as an area equal to the width of four seats immediately in front of each seat) or within a consumer's extended field of view (defined as an area equal to the width of eight seats in front of each seat), four distinctly different panels 20, 20′, 20″, 20′″ are sequentially rotated so that each consumer can view each of these different panels 20, 20′, 20″, 20′″ while sitting in one seat 12 (see FIG. 5). This method of spacing and rotation can enhance the revenue producing potential of the system 30 because it advantageously creates, for example, 16 separate advertisements A-P (see FIG. 5C) viewable by the person in the seat 12 to feature and promote.

Note, the number of advertisements can vary depending upon the positioning of the seats 12 (see FIGS. 1 and 5A-C) which can result in a different field of view. Note also, although a different positioning of the various advertisements within each panel 20 is within the scope of the present invention, where the field of view of the average of a plurality of consumers is four seats 12, having four equally sized and linearly sequenced advertisements, e.g. A, B, C, D (see FIG. 5A-C) provides significant advantages, as described above.

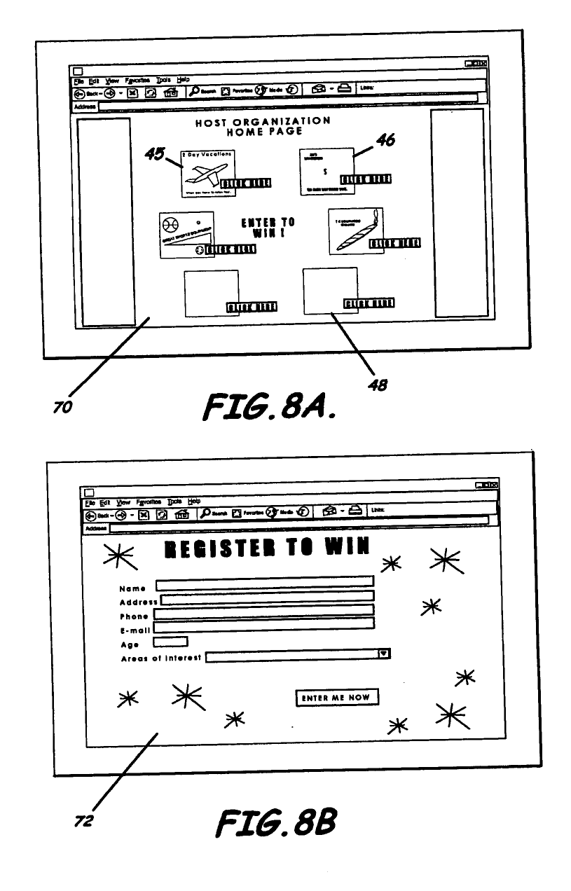

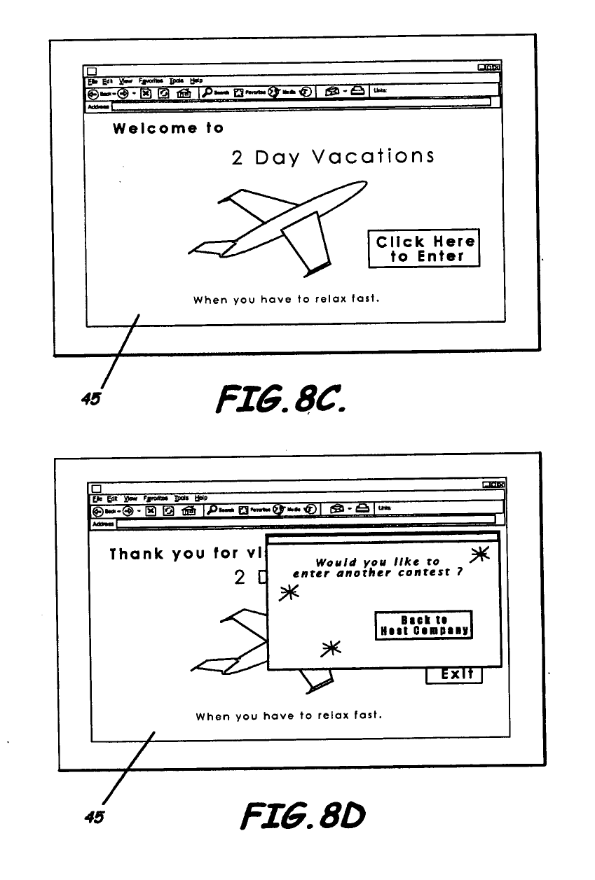

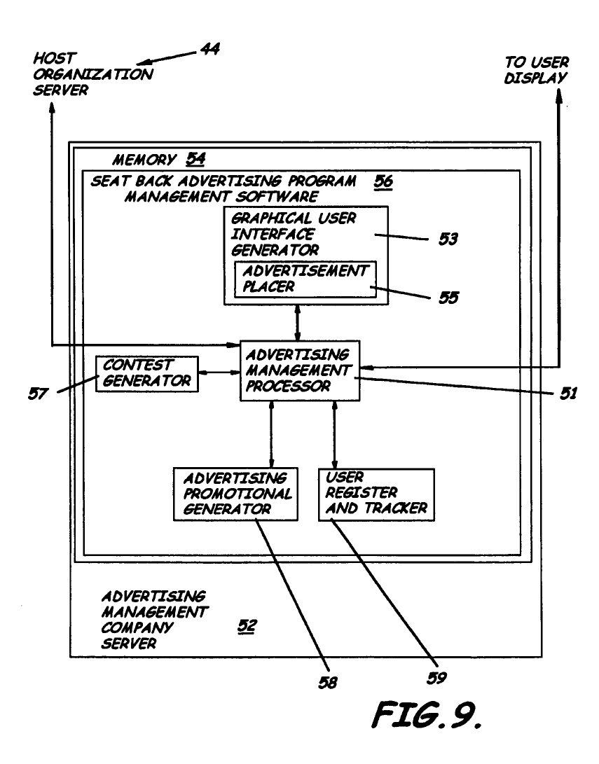

In the preferred embodiment of the present invention, each advertiser can be required to sponsor, as part of program packaging, a giveaway contest. By featuring meaningful prizes in these contests, a “call-to-action” program can enhance consumer interaction with each advertiser. A very simple “call-to-action” program message or indicia of a call-to-action program or advertisement 25 (e.g., including a web-site address or domain address) can be featured in an unobtrusive manner on each advertisement in each sub-panel 22, 24, 26, 28 within each panel 20, printed in one or more languages, e.g., both Spanish and English. This “call-to-action” program can be supported by a single source website (see FIGS. 8A-8D) that features the details for each advertiser's unique contest, and allows each consumer to register to win the prize offered. Winners of each contest, for example, can be selected according to how each advertiser structures their contest. This can be part of the process of each consumer's registration for each contest.

As shown in FIGS. 6-8D, in addition to consumers being able to register at their own home computers 60 or a user's personal digital assistant (“PDA”) 62, because every person attending a game cannot be counted on to be computer literate, nor presumed to own or have access to a computer, dedicated computer kiosks 64 can be strategically positioned around the MPV 40, e.g., a stadium, so consumers can register at the stadium 40, too. Trained attendants also can host each stadium kiosk 64 or a help desk having a separate computer terminal 66, in order to answer questions and assist consumers who need help with entering registration data. The data collected, for example, can be shared only with the host organization 32 and each advertiser to which the data relates. This website component of the seat back advertising system 30 advantageously can serve as a value-added enhancement to the overall effectiveness of the plan and help promote greater brand awareness.

Also, embodiments of a seat back advertising system 30 of the present invention can be positioned as a new program and strategy designed to increase the host organization's revenue and maximize direct consumer exposure for each advertiser 35, 36, 38. Unique to the traditional stadium 40, or other MPV promotional opportunities offered to advertisers 35, 36, 38, embodiments of a seat back advertising system 30 of the present invention can focus on the individual consumer attending the game, increase exposure time of each brand displayed, and provide a “call-to-action” program to drive traffic, or broker attention, to each advertiser's promotion 45, 46, 48 and website (see FIGS. 8A-D). The system 30 can help optimize impression time for advertisers, and retain top-of-mind awareness for more effective consumer recall and market penetration. An embodiment of a system 30 of the present invention can include:
Custom seat back advertising panel 20;
A plurality (shown as four) of different advertisers per panel 20 and a rotation of a plurality (shown as four) of unique advertisements within each sub-panel 22, 24, 26, 28 on each panel 20, e.g., a total of 16 advertisements A-P (see FIG. 5C);
Exclusivity by product/service category;
Flexibility to change messages after each series package, and between games; and
Ability to build consumer relationship beyond the game, such as, for example, through a website (see FIGS. 8A-8D).

A seat back advertising system 30 of the present invention, for example, can allow the host organizations sales staff to offer current and new advertisers an innovative and exciting opportunity to participate alongside some of the country's premiere brands without being “locked-in” for an extended period of time, or utilizing their entire advertising budgets. It is believed that this advertising medium can create exceptional “impression time” with each consumer because of the location of the panels 20, 20′, 20″, 20′″ and/or position of the advertisements A-P (see FIGS. 4-5) and how they are displayed. Because of pre-established relationships and consistency of the host organization's policies and procedures, all sales activity can be deferred to the host organization's sales staff, or such activities can be managed and administered by another source.

Embodiments of this system 30, for example, also allow the advertiser for a sports game, e.g., baseball, to select a specific number of games at which they want to participate and promote their brand, ranging for one game, to a select series, to an entire season of home games. As proposed, home series packages (multiple options from which to choose) can be offered for greater consumer impact. A plurality, e.g., four advertisements or advertising spots A-D, E-H, I-L, or M-P, separately positioned in each sub-panel 22, 24, 26, 28, can be featured on each panel 20, 20′, 20″, 20′″, respectively, and with there preferably being four different panels 20, 20′, 20″, 20′″ to sequentially rotate the various advertisements A-P in order to maximize exposure. For example, with an estimated 36,000 usable seats 12, this strategy is intended to ensure that each advertiser can receive exposure to as many as 36,000 consumers, though only having a brand displayed on 9,000 seat backs 15 in the MPV 40, e.g. a stadium, at any one time.

Creating a “call-to-action” program that is measurable allows for a unique selling proposition (“USP”) for each of the advertisers participating in the program. This website-based strategy can be included as an additional component of a seat back advertising system 30. An embodiment of a seat back advertising system 30 having an advertising management company website 70 (see FIG. 8) can (i) provide a registration form 72 to register consumers for each advertiser's contest giveaway; (ii) direct each consumer to the host organization's own website or a website linked to the host organizations own website; and (iii) broker attention to each advertiser's home page after registration (see FIGS. 8A-8D).

A “call-to-action” message or indicia of the call-to-action program or advertisement 25 on each panel 20, 20′, 20″, 20″, such as, for example, a simple web-based address such as “Register to Win at www.insertawebsitehere.com” or some other unique and specially-dedicated Internet or domain address, or specific keyword used by select service providers representing the unique address, can be printed in one or more languages, e.g., both Spanish and English. Contest registration can be linked to the host organization's website typically located on a host organization server 44 and each sponsor's website 45, 46, 48, typically located on each individual advertiser's servers. The system 30 can allow for additional brand exposure for the advertiser 35, 36, 38, and the host organization 32. It can, by default, also serve as an additional tool to enhance the overall effectiveness of a seat back advertising system 30. The management, collection and reporting of data assembled from each contest registration can be the responsibility of a consulting firm, vendor, or management firm, for example. Each advertiser can be responsible for creating and promoting their own promotional contest, subject to the host organization's approval of the contest rules and prizes offered.

If all the sub-panels 22, 24, 26, 28 on each panel 20, 20′, 20″, 20′″ are sold, this will result in an estimated several dollars of gross revenue for the host organization 32, per panel 20, 20′, 20″, 20′″. Pricing can be offered in multiple and different packages based on the seating capacity in an MPV 40, and based on seasonal or periodic events or schedules. Pricing of the seat back advertising system 30, for example, can be attractive compared to other promotional opportunities within professional sports stadiums, and allows for tremendous “capture time” with the consumer. The consumer can be facing, within the consumer's immediate and extended fields of view, the advertiser's messages during an entire game or event.

Based on the average length of each game or event, the estimates of a seat back advertising system 30 can be premised on extrapolated or statistically valid averages. Though the length of games and events vary, based on multiple factors affecting the outcome and duration, the average length of time can be a basis of the system metrics and estimated costs. In comparing this form of advertising to other stadium promotional opportunities, embodiments of a seat back advertising system 30 of the present invention can be very appealing for several reasons:
Advertisers have direct exposure a massive number, e.g., tens of thousands, of consumers during an entire game or event;
Advertisers can select from a multiple different advertising packages;
Advertisers can promote unique promotions and a sponsorship with the host organization;
Advertisers benefit from a highly attentive audience, receive extended viewing time and enhance brand recall and website traffic; and
Host organization benefits from additional revenue that can prove to be substantial.

It is estimated that each consumer attending a host organization game or event, for example, will typically have an immediate field of viewing estimated to be an area equal to the width of four seats 12, which, in this particular configuration, can provide each consumer with the ability to view all sixteen advertising sub-panels 22, 24, 26, 28 for the entire length of a game. Advertisers have the opportunity to enhance their brand exposure with premium visibility over a substantial period of collective time when the viewer exposure is aggregated on a per game or event basis.

In the preferred embodiment of the present invention, a consulting firm, vendor, or management firm, such as, for example, advertising management company 50, can manage the entire plan and system 30, thus, relieving a host company 32 from the requirement to perform such duties. Management duties can include coordinating the manufacturing of all panels 20, 20′, 20″, 20′″, interface and communication with each sponsor's brand managers, overseeing product fulfillment, inventory management, labor selection and supervision in connection with installation, de-installation and constant between-games replacement/maintenance. A business consulting company that provides representative and advisory services in a variety of industries can devote a significant amount of its resources and time to the strategic development and management of brand, business and marketing plans. It can, through selected affiliates, manage the packaging, fulfillment and delivery aspects of the system 30. This includes product specification, artwork and design application, conversion, production, manufacturing, installation, monitoring, and freshening of panels 20, 20′, 20″, 20′″ on a per game basis. Fulfillment and delivery in connection with a seat back advertising system 30 can coincide with each game and with how the program packages are offered by the host organization. Should any of the seat back panels be damaged or removed, the consulting firm or vendor and selected affiliates can ensure, in performing its fulfillment and delivery duties, that every panel will be replaced (if torn, removed or damaged) and free of defects.

This can be a turnkey, managed solution system, with very little host organization involvement after sales. In this manner, the manufacturing of all signage or panel products also can be professionally and reliably handled, on a turnkey basis. The panel products 20, 20′, 20″, 20′″ can be printed, packaged and installed through arrangements between the consulting firm or vendor and selected affiliates. Once advertisers are identified and processed, a host organization representative can communicate with staff of the advertising management company 50 to ensure there is a consistent flow of accurate and timely data. The advertising management company 50 can communicate effectively with the host organization's representatives regarding any issues that arise in connection with production and package fulfillment parts of the program.

Because the appearance and cleanliness of the stadium facilities and seating areas are important to host organizations, vendors, advertisers, and users alike, careful attention can be given to this aspect of the system 30 in order to ensure that there is no damage to any seat back 15, and that a special adhesive-backed panel 20 or other product can be used to eliminate the possibility of residue buildup on seat backs 15. The panel products 20, 20′, 20″, 20′″ used in this system 30 allow for the following:
Exceptional quality and superior printing;
Consistency of image and brand standards;
Quality installation and replacement capability; and
No adhesive residue/damage to the seat back 15.

As illustrated in FIGS. 1-10, embodiments of the present invention advantageously provide an advertising business system and method that include attaching a removable and replaceable panel 20 (see FIG. 4) to a back surface 15 of seats 12 in a multi-purpose venue and displaying host organization and/or third-party paid visual advertisement on a viewing surface of the panel 20. That is, the panel 20 can include the viewing surface, which can have a substrate with a pre-selected thickness, a coloration material associated with the substrate forming a desired advertising pattern of at least one color, and a removable backing 21. The substrate can include a self-adhesive substance 23 on the opposing face of the viewing surface covered by the backing 21 adapted to be removed prior to attachment to a back surface 15 of a seat 12 in a multi-purpose venue.

Embodiments of the present invention also can include a method for sequentially rotating and spacing a plurality of advertising panels 20, 20′, 20″, 20′″. The method includes positioning each of a plurality of different advertising panels 20, 20′, 20″, 20′″ on a back of a different seat 12 in a multi-purpose venue. Each of the plurality of advertising panels 20, 20′, 20″, 20′″ can have a same advertisement sub-panel sequence (see FIG. 5A). Each of the plurality of advertising panels 20, 20′, 20″, 20′″ can advantageously have a different advertisement sub-panel sequence of the same advertisements A, B, C, D (see FIG. 5B). Each of the plurality of advertising panels 20, 20′, 20″, 20′″ can also advantageously each have a different advertisement A-D, E-H, I-L, and M-P, respectively (see FIG. 5C). Each different advertisement spot sequence 22, 24, 26, 28 also can be a plurality of the same advertisement, or a combination thereof.

An embodiment of a seat back advertising system 30 and methods of the present invention also provides for enhancing target audience and user activity by promoting contest-based incentives as rewards for responding to contests and advertised promotional participation opportunities. The system 30 can include a call-to-action ad slogan, spot, or indicia indicating a call-to-action program or advertisement 25 displayed on a viewing surface of an advertising panel 20. The call-to-action message 25 can include a web-based address for an interactive web-based program or program product, as will be understood by those skilled in the art, including seat back advertising management software 56 accessible through a user interface having access to a communications network. Note, the program product and/or software 56 can be in the form of microcode, programs, routines, and symbolic languages that provide a specific set for sets of ordered operations that control the functioning of the hardware and direct its operation, as known and understood by those skilled in the art.

As perhaps best shown in FIGS. 8A-8D and FIG. 9, a homepage is provided that is designed to place a pre-selected form of web advertising for the different promotional opportunities and contests of each advertiser or host organization participating in an advertising program displayed in prominent view on the homepage. Associated hyperlinks, preferably including icon anchors, on the homepage direct users to multiple secondary web pages describing the terms of each contest and promotional participation opportunity sponsored by an advertiser or host organization participating in the advertising program. An associated hyperlink, also preferably including an icon anchor, directs a user to a subsequent web page that facilitates the registration of the user through the collection of identifying data entered into a registration form. An associated hyperlink, also preferably including an icon anchor, allows the user to register the identifying data in any one or more of the different promotional opportunities or product-promotional prize-drawing games of chance and contests sponsored by each advertiser or host organization participating.

The interactive web-based program of seat back advertising management software 56 can further include after completion of the required data entry fields on the registration page or form 72, a plurality of associated icons and hyperlinks offered for users desiring to enter the registration data in a single contest, means for transmitting the unique identifying data of the user upon engagement or selection of an icon and hyperlink to a website associated with the homepage, and means for receiving from the homepage data indicating that the user successfully entered all of the data fields in the registration form, and that the user performed at least one predetermined task requiring entry of their data in any one or more of the contests and promotional participation opportunities or product-promotional prize-drawing games of chance sponsored by an advertiser or host organization participating in the advertising program, and means for storing the received data in memory.

The means for transmitting, for example, can include a user register and tracker 59, the means for receiving can include a contest generator 57 and an advertising promotional generator 58, and the means for storing can includes memory 54 (see FIG. 9). The seat back advertising program management software, as understood by those skilled in the art, can also include an advertising management processor 51, to process management data and commands and a graphical user interface (“GUI”) generator 53 to generate GUI pages including an advertisement placer to selective position advertisements on a host organization's website, for example.

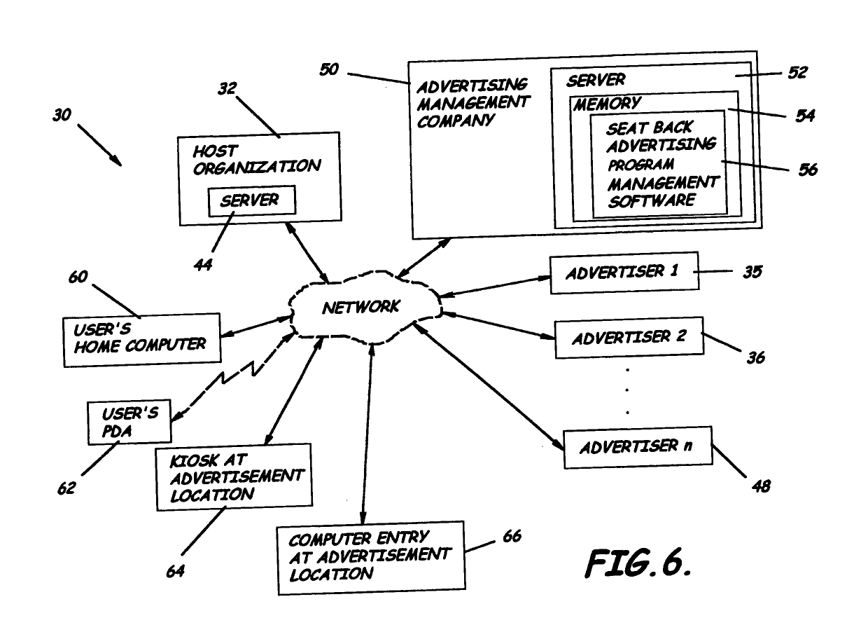

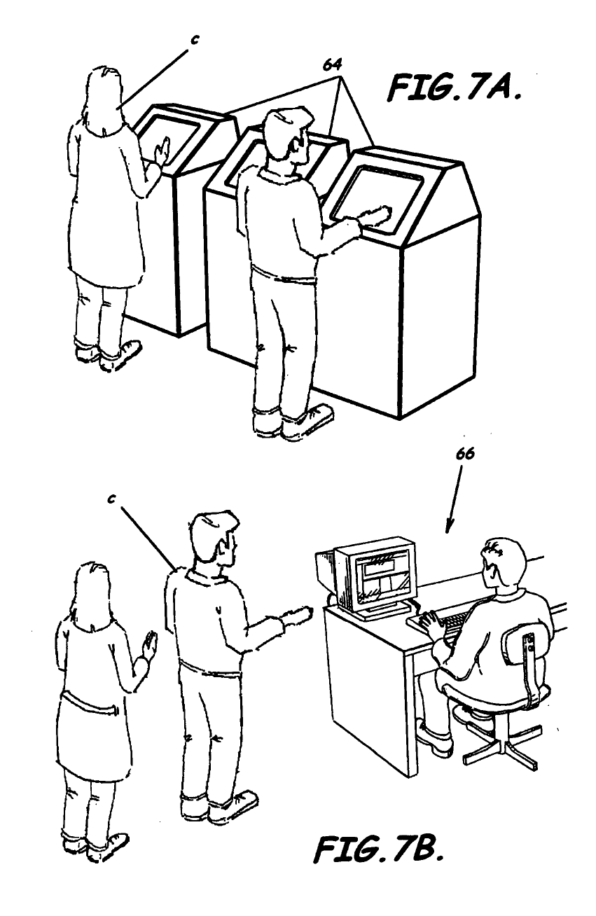

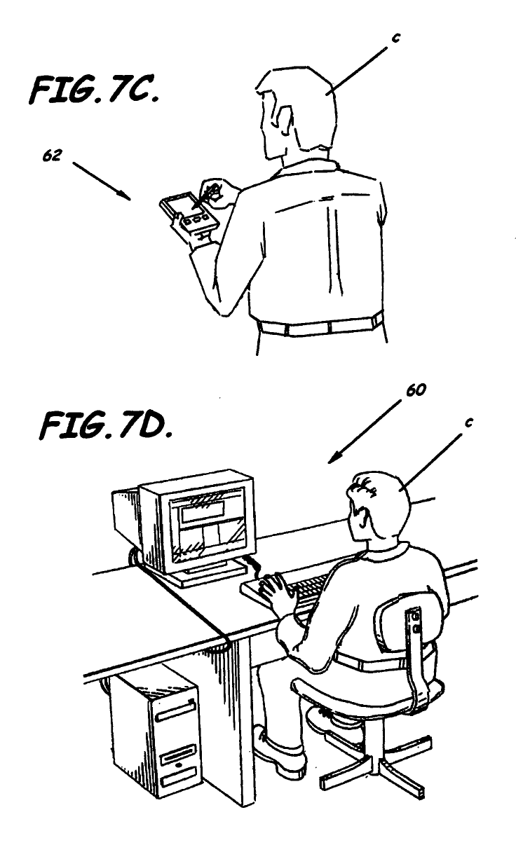

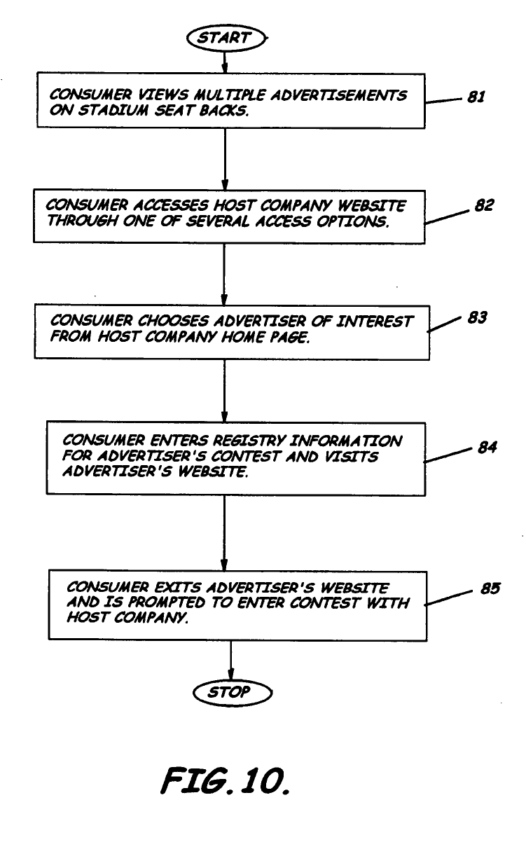

As perhaps best shown in FIG. 10, in operation, a consumer typically views (block 81) the advertisements A-D, E-H, I-L, and M-P located within sub-panels 22, 24, 26, 28, of advertising panels 20, 20′, 20″, 20′″, positioned on the seat backs 15 of a corresponding plurality of seats 12 typically at a stadium 40 (see FIGS. 1 and 5), each advertisement preferably having indicia of a product-promotional prize-drawing game of chance or contest. Interested in at least one of the contests or advertised products or services, the consumer mentally notes the “the call-to-action” message or indicia indicating a call-to-action advertisement 25 (see FIG. 4). The consumer then accesses a host company website 70 (block 82) through use of various options such as a home computer 60 (see FIG. 7D), PDA (see FIG. 7C), stadium kiosk 64 (see FIG. 7A), stadium help desk having a separate computer terminal 66 (see FIG. 7B), or other device known to those skilled in the art. The consumer then chooses an advertisement (advertiser) of interest (block 83) and enters registry information for the advertiser's contest (block 84) and visits the advertiser's website (see FIGS. 8A-C). Upon completion of viewing the advertiser's website, the consumer initiates exit of the advertiser's website and is prompted (block 85) to enter another contest with the host company (see FIG to 8D).

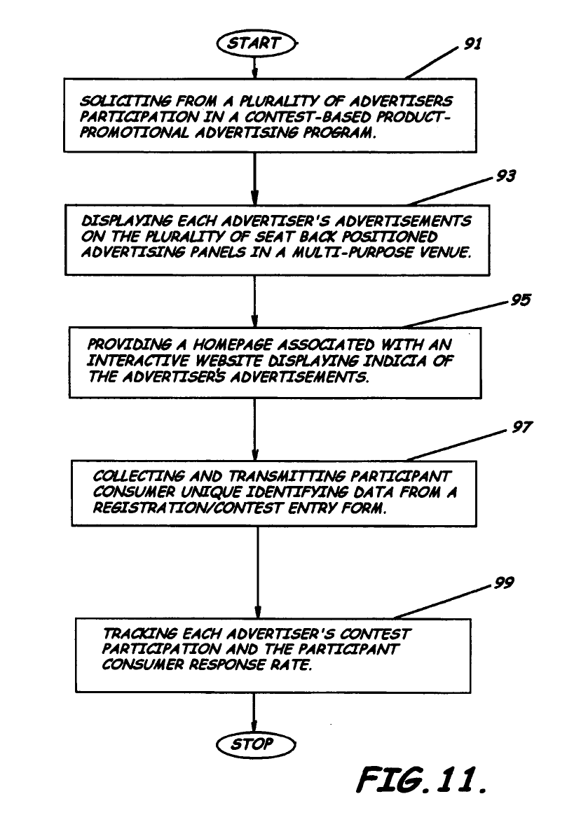

As perhaps best shown in FIG. 11, embodiments of the present invention also include a method of entering an advertising arrangement for a plurality of advertisers to advertise on a plurality of seat backs 15 in a multi-purpose venue 40. For example, in an embodiment of the present invention the method includes the steps of: soliciting from a plurality of advertisers (block 91), participation in an advertising program that promotes contest-based incentives as rewards for responding to advertisements tailored for each advertiser; and displaying (block 93) each advertiser's advertisements on the plurality of seat back positioned advertising panels 20 (see FIG. 4) in a multi-purpose venue (see FIG. 1). In the preferred embodiment of the present invention, each advertiser is required to sponsor a product-promotional prize-drawing game of chance as a methodology of an enticing consumers to access and view a homepage 70, to provide registration information (see FIG. 8B) and view the advertisers web-based promotions 45, 46, 48 (see FIGS. 8A and 8C). The advertising panels 20 each include sub-panels 22, 24, 26, 28, (see FIG. 4) having at least one advertisement including indicia of a product-promotional prize-drawing game of chance or contest, and indicia indicating a call-to-action advertisement 25 displayed on the viewing surface of the panel 20. The call-to-action advertisement preferably includes a web-based address for the interactive website 70 accessible through a user interface having access to a communication network.

The method also includes providing a homepage (block 95) associated with an interactive website 70 having a plurality of different advertisements/advertiser's promotions 45, 46, 48, (see FIG. 8A) corresponding with the advertisements displayed on the plurality of seat back positioned advertising panels 20 of the advertising program. The homepage 70 can provide at least one registration form 72 having a set of data entry fields and a participant consumer selectable hyperlink for each advertiser's website associated with the homepage 70 using icons in the form of web-based promotions 45, 46, 48. The registration form facilitates registration of the participant consumer for a selected product-promotional prize-drawing game of chance or contest of interest through the collection of participant consumer unique identifying data entered into the registration form by the participant consumer. This data is both useful to the host company and the advertisers.

The method includes collecting and transmitting the participant consumer unique identifying data (block 97) from the registration form 72, in response to the participant consumer entering participant consumer unique identifying data into the data entry fields of the registration form and selecting an associated participant consumer selectable hyperlink. The participant consumer unique identifying data can be transmitted to both the host organization and the selected advertiser associated with the homepage 70. Further, the collected data can be stored and used for statistical and marketing purposes. To provide accountability for both the host company and the advertisers, each advertiser's contest participation and the participant consumer response rate can be tracked (block 99).

It is important to note that while embodiments of the present invention have been described in the context of a fully functional system, those skilled in the art will appreciate that the interactive mechanism of the present invention and/or aspects thereof are capable of being distributed in the form of a computer readable medium of instructions in a variety of forms for execution on a processor, processors, or the like, and that the present invention applies equally regardless of the particular type of signal bearing media used to actually carry out the distribution. Examples of computer readable media include: nonvolatile, hard-coded type media such as read only memories (ROMs) or erasable, electrically programmable read only memories (EEPROMs), recordable type media such as floppy disks, hard disk drives and CD-ROMs, and transmission type media such as digital and analog communication links.

As shown in FIGS. 6-10, embodiments of the present invention also include a computer readable medium that is readable by a computer to provide enhanced target audience and user activity by promoting contest-based incentives as rewards for responding to advertisements having indicia of a product-promotional prize-drawing game of chance and displayed on a plurality of seat back positioned advertising panels of an advertising program.

For example, in an embodiment of the present invention, the computer readable medium includes a set of instructions or program product that, when executed by the computer, such as, for example, advertising management company server 52 or host company server 44, cause the computer to perform the operation of displaying a home page 70 having a plurality of different advertisements, such as, for example, the illustrated advertiser's promotions 45, 46, 48, (see FIG. 8A) corresponding with the advertisement displayed on the plurality of seat back positioned advertising panels 20 of the advertising program (see FIG. 4). The operations performed also include displaying a plurality of participant consumer selectable hyperlinks preferably having anchors in the form of the illustrated advertiser's promotions 45, 46, 48, (see FIG. 8A) to provide selection of a product-promotional prize-drawing game of chance of interest. The operations performed also can include providing at least one registration form 72 (see FIG. 8B) having a set of data entry fields and a participant consumer selectable hyperlink to an advertiser's website associated with the homepage, which can be positioned to be “call-up” either upon the participant consumer selecting the product-promotional prize-drawing game of chance of interest or separately through a separate registration hyperlink (not shown). The registration form 72 facilitates registration of the participant consumer for the selected product-promotional prize-drawing game of chance of interest through the collection of participant consumer unique identifying data entered into the registration form 72. Upon “clicking” or launching the hyperlink to enter the data, the participant consumer's unique identifying data can be collected from the registration form, and transmitted to either or both of the advertiser/advertiser's website associated with the homepage and to the host company, preferably while simultaneously displaying the advertiser's website.

Upon completion of reviewing the advertiser's website, when the participant consumer attends to exit the site, a participant consumer selectable hyperlink back to the homepage can be displayed. Advantageously, such operation provides the participant consumer convenient access to another product-promotional prize-drawing game of chance for another advertiser, thus enhancing the probability of a consumer entering additional gains of chance or contests and thus, being exposed to the advertiser's web-based product information. Advantageously, each advertiser's contest participation and participant consumer response rate can be tracked.

In the drawings and specification, there have been disclosed embodiments of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification and as defined in the appended claims. For example, the host organization home page can be the actual host organization's web page or a web page created for the host organization and specifically to display the various advertising promotional opportunities/contests coinciding with the seat back advertising system. Also for example, the seat back advertising program management software 56 was described as loaded in memory of the advertising management company server. Portions of the software can, however, be located in the host organization server or in servers associated with the individual advertisers sponsoring the promotions/contests.

1. An advertising business method, the method comprising:
attaching a removable and replaceable panel to a back surface of seats in a multi-purpose venue; and
displaying at least one third-party paid visual advertisement on a viewing surface of the panel, the panel including the viewing surface, the viewing surface having a substrate with a pre-selected thickness, a coloration material associated with the substrate forming a desired advertising pattern of at least one color, and a removable backing.

2. A method as defined in claim 1, wherein a host organization advertisement also is on the viewing surface, and wherein the substrate comprises a self-adhesive substance on the opposing face of the viewing surface covered by the backing adapted to be removed prior to application and attachment to a back surface of a seat in a multi-purpose venue.

3. A method as defined in claim 1,
wherein the at least one third-party paid visual advertisement includes indicia indicating a product-promotional prize-drawing game of chance; and
wherein the at least one visual advertisement includes indicia indicating a call-to-action advertisement displayed on the viewing surface of the panel, the call-to-action advertisement including a web-based address for an interactive website accessible through a user interface having access to a communication network.

4. A method as defined in claim 3, wherein the interactive website includes a homepage designed to place a pre-selected form of web advertising for a plurality of different product-promotional prize-drawing games of chance for each advertiser of a corresponding plurality of third-party paid visual advertisements, each different product promotional prize-drawing game of chance displayed in prominent view on the homepage.

5. A method as defined in claim 4, wherein each different product-promotional prize-drawing game of chance displayed on the homepage is iteratively accessible so that upon exiting a first selected product-promotional prize-drawing game of chance, the user is provided a hyperlink to return to the homepage, to thereby select a second displayed product-promotional prize-drawing game of chance.

6. A method as defined in claim 4, further comprising providing access to a registration form having data entry fields that facilitate registration of the user through collection of user unique identifying data entered into the registration form.

7. A method as defined in claim 6, wherein responsive to the user entering a user unique identifying data into the data entry fields of the registration form and performing at least one predetermined task requiring entry of the unique identifying data in at least one of the advertised product-promotional prize-drawing games of chance, the method further comprises:
collecting the user unique identifying data entered into the registration form;
transmitting the user unique identifying data to at least one of a host organization website and an advertiser's website associated with the homepage; and
storing the collected data.

8. A method for sequentially rotating and spacing a plurality of advertising panels, the method comprising the step of:
positioning each of a plurality of different advertising panels on a back of a different seat in a multi-purpose venue, each of the plurality of advertising panels having a plurality of indicia each indicating a corresponding different promotional advertisement and positioned in a sequential order.

9. A method as defined in claim 8, wherein each advertising panel includes a same set of the plurality of indicia, and wherein the method further comprising the step of positioning the set of the plurality of indicia of each of the plurality of advertising panels in a sequence so that adjacent advertising panels have a different sequence.

10. A method as defined in claim 9, wherein a number of the plurality of indicia for each advertising panel is equal to a number of panels positionable in a predetermined average expected field of view of a plurality of users of the multi-purpose venue, the method further comprising the step of positioning the different indicia of each of the plurality of advertising panels in a different serial sequence so that each advertising panel within the predetermined average expected field of view of each of the plurality of users has indicia positioned in a different sequence.

11. A method as defined in claim 8, wherein a number of unique indicia each indicating a different promotional advertisement is equal to a product of a number of panels positionable in a predetermined average expected field of view of a plurality of users of the multi-purpose venue and a number of indicia each indicating a different promotional advertisement on each advertising panel, the method further comprising the step of positioning the plurality of different advertising panels within a predetermined average expected field of view of each of the plurality of users of the multi-purpose venue, so that each indicia indicating a different promotional advertisement within the predetermined average expected field of view of each of the plurality of users is different from each other of the indicia indicating a different promotional advertisement within the predetermined average expected field of view of each of the plurality of users, to thereby minimize over-saturation of any one advertisement impression within a user's field of view and so that each of the plurality of users can view each unique indicia indicating a different promotional advertisement from multiple seat locations.

12. A system for enhancing target audience and user activity by promoting contest-based incentives as rewards for responding to contests and advertised promotional participation opportunities, the system comprising:
a call-to-action advertisement displayed on a viewing surface of an advertising panel, the call-to-action advertisement including a web-based address;
an interactive web-based program accessible through a user interface having access to a communications network;
a homepage designed to place a pre-selected form of web advertising for the different promotional participation opportunities and contests of each advertiser or host organization participating in an advertising program displayed in prominent view on the homepage;
associated hyperlinks on the homepage directing users to multiple secondary web pages describing the terms of each contest and a product-promotional prize-drawing game of chance sponsored by an advertiser or host organization participating in the advertising program;
an associated hyperlink directing a user to a subsequent web page that facilitates the registration of the user through the collection of identifying data entered into a registration form; and
an associated hyperlink that allows the user to register the identifying data in any one or more of the different promotional opportunities and contests sponsored by each advertiser or host organization participating.

13. A system as defined in claim 12, wherein each anchor for each hyperlink can include an icon.

14. A system as defined in claim 12, wherein the program further includes after completion of the required data field on the registration page,
a plurality of associated hyperlinks offered for users desiring to enter the registration data in a single contest;
means for transmitting the unique identifying data of the user upon engagement or selection of a hyperlink to a website associated with the homepage; and
means for receiving data from the homepage indicating that the user successfully entered all of the data entry fields in the registration form, and that the user performed at least one predetermined task requiring entry of their data in any one or more of the product-promotional prize-drawing games of chance sponsored by an advertiser or host organization participating in the advertising program; and
means for storing the received data in memory.

15. A system as defined in claim 14, wherein the means for transmitting includes a user register and tracker, wherein the means for receiving includes a contest generator and an advertising promotion generator, and wherein the means for storing includes memory.

16. A system as defined in claim 12, further comprising means for tracking user activity, means for participation statistics and reports and, means for compiling and reporting data.

17. A computer readable medium that is readable by a computer to enhance target audience and consumer activity by promoting contest-based incentives as rewards for responding to advertisements having indicia of a product-promotional prize-drawing game of chance and displayed on a plurality of seat back positioned advertising panels of an advertising program, the computer readable medium comprising a set of instructions that, when executed by the computer, cause the computer to perform the following operations:
displaying a home page having a plurality of different advertisements corresponding with the advertisement displayed on the plurality of seat back positioned advertising panels of the advertising program;
displaying a plurality of participant consumer selectable hyperlinks to provide selection of a product-promotional prize-drawing game of chance of interest;
providing at least one registration form having a set of data entry fields and a participant consumer selectable hyperlink to an advertiser's website associated with the homepage, responsive to the participant consumer selecting the product-promotional prize-drawing game of chance of interest, the registration form facilitating registration of the participant consumer for the selected product-promotional prize-drawing game of chance of interest through the collection of participant consumer unique identifying data entered into the registration form;
collecting the participant consumer unique identifying data from the registration form, responsive to the participant consumer entering participant consumer unique identifying data into the data entry fields of the registration form and selecting the associated participant consumer selectable hyperlink;
transmitting the unique consumer participant unique identifying data to the advertiser's website associated with the homepage;
displaying the advertiser's website; and
displaying a participant consumer selectable hyperlink back to the homepage, responsive to the participant consumer initiating exit of the advertiser's website associated with the homepage, to thereby provide the participant consumer access to another product-promotional prize-drawing game of chance for another advertiser.

18. A computer readable medium that is readable by a computer to provide enhance target audience and consumer activity by promoting contest-based incentives as rewards for responding to advertisements having indicia indicating a product-promotional prize-drawing game of chance and displayed on a plurality of seat back positioned advertising panels of an advertising program, the computer readable medium comprising a set of instructions that, when executed by the computer, cause the computer to perform the following operations:
displaying a home page having a plurality of different advertisements corresponding with the advertisements displayed on the plurality of seat back positioned advertising panels of the advertising program;
providing a plurality of participant consumer selectable hyperlinks to provide selection of a product-promotional prize-drawing game of chance of interest;
providing a hyperlink directing a participant consumer to a subsequent web page that facilitates the registration of the participant consumer through the collection of identifying data entered into a registration form having data entry fields and a participant consumer selectable hyperlink;
receiving data from the homepage, responsive to the participant consumer entering participant consumer unique identifying data into the data entry fields of the registration form and selecting the associated participant consumer selectable hyperlink, the data indicating that the participant consumer successfully completed all required data entry fields in the registration form and that the participant consumer performed at least one predetermined task requiring entry of the unique identifying data in at least one product-promotional prize-drawing game of chance;
collecting the participant consumer unique identifying data entered into the registration form; and
storing in memory the received participant consumer unique identifying data entered into the registration form.

19. A computer readable medium as defined in claim 18, further comprising a set of instructions that, when executed by the computer, cause the computer to perform the following operation:
displaying a participant consumer selectable hyperlink back to the homepage, responsive to the participant consumer initiating exit of a web page associated with the at least one of the product-promotional prize-drawing game of chance, to thereby provide the participant consumer access to the remaining plurality of advertised promotional participation opportunities.

20. A method of entering an advertising arrangement for a plurality of advertisers to advertise on a plurality of seat backs in a multi-purpose venue, the method comprising the steps of:
soliciting from a plurality of advertisers, participation in an advertising program that promotes contest-based incentives as rewards for responding to advertisements tailored for each advertiser;
displaying each advertiser's advertisements on the plurality of seat back positioned advertising panels in a multi-purpose venue, the advertising panels including at least one advertisement having indicia of a product-promotional prize-drawing game of chance; and
providing a homepage associated with an interactive website having a plurality of different advertisements corresponding with the advertisements displayed on the plurality of seat back positioned advertising panels of the advertising program.

21. A method as defined in claim 20, further comprising the step of providing at least one indicia indicating a call-to-action advertisement displayed on the viewing surface of each of the plurality of advertising panels, the call-to-action advertisement including a web-based address for the interactive website accessible through a user interface having access to a communication network.

22. A method as defined in claim 21, further comprising the step of requiring each advertiser to sponsor a product-promotional prize-drawing game of chance.

23. A method as defined in claim 20, further comprising the steps of:
providing at least one registration form having a set of data entry fields and a participant consumer selectable hyperlink for each advertiser's website associated with the homepage, the registration form facilitating registration of the participant consumer for a selected product-promotional prize-drawing game of chance of interest through the collection of participant consumer unique identifying data entered into the registration form by the participant consumer;
collecting the participant consumer unique identifying data from the registration form, responsive to the participant consumer entering participant consumer unique identifying data into the data entry fields of the registration form and selecting the associated participant consumer selectable hyperlink;
transmitting the participant consumer unique identifying data to at least one of a host organization website and an advertiser's website associated with the homepage;
storing the collected data; and
tracking each advertiser's contest participation and participant consumer response rate.

24. A method of entering an advertising arrangement for at least one advertiser to advertise on a plurality of seat backs in a multi-purpose venue, the method comprising the steps of:
soliciting from at least one advertiser, participation in an advertising program that promotes contest-based incentives as rewards for responding to advertisements tailored for each at least one advertiser;
displaying the at least one advertiser's advertisement on the plurality of seat back positioned advertising panels in a multi-purpose venue, the advertising panels including at least one advertisement having indicia of a product-promotional prize-drawing game of chance; and
providing a homepage associated with an interactive website having an advertisement corresponding with the at least one advertiser's advertisement displayed on the plurality of seat back positioned advertising panels of the advertising program.
